(19) United States
(12) Patent Application Publication
(10) Pub. No.: US 2026/0077772 A1
(43) Pub. Date: Mar. 19, 2026

(54) Distributed Subsystems with Embedded AI Compute in an Automotive System

(71) Applicant: Tenstorrent USA, Inc., Austin, TX (US)

(72) Inventors: Luke Yen, Woodinville, WA (US); Thaddeus Fortenberry, Dripping Springs, TX (US)

(21) Appl. No.: 19/283,941

(22) Filed: Jul. 29, 2025

Related U.S. Application Data
(60) Provisional application No. 63/694,866, filed on Sep. 15, 2024.

(51) Int. Cl. B60W 50/00; B60R 16/023; B60W 10/06; B60W 10/10; B60W 10/26

(52) U.S. Cl. CPC B60W 50/0098; B60R 16/0231; B60W 10/06; B60W 10/10; B60W 10/26; B60W 2050/0039; B60W 2710/06; B60W 2710/10; B60W 2710/242

(57) ABSTRACT

Systems and methods related to distributed subsystems with embedded artificial intelligence (AI) compute in automotive systems are disclosed herein. A disclosed automotive computing architecture includes a network, a plurality of networked subsystems in operative communication using the network, and a set of AI accelerators in a one-to-one correspondence with the plurality of networked subsystems. The set of AI accelerators may conduct AI computations for their respective networked subsystems without using the network, reducing latency. The set of distributed AI accelerators may each be optimized for the specific workloads of their subsystems. By using distributed AI accelerators, each task can be handled by hardware optimized for its specific needs, resulting in higher efficiency, lower latency, and better power management. Furthermore, the distributed AI accelerators can provide greater scalability, redundancy, and fault tolerance, enabling better performance across diverse workloads.

### CROSS REFERENCE TO RELATED APPLICATIONS

This application claims the benefit of U.S. Provisional Ser. No. 63/694,866 , filed Sep. 15, 2024, which is incorporated by reference herein in its entirety for all purposes.

### BACKGROUND

Artificial intelligence (AI) is revolutionizing the automotive industry by enhancing vehicle safety, efficiency, and user experience. AI algorithms power advanced driver-assistance systems (ADAS) such as adaptive cruise control, lane-keeping assistance, and automatic emergency braking, which collectively contribute to reducing accidents and improving driving comfort. Moreover, AI enables autonomous driving technologies by processing data from sensors and cameras to make real-time decisions, navigating complex traffic situations, and adapting to varying road conditions. Beyond driving, AI is also improving vehicle maintenance through predictive analytics, which forecasts potential issues before they become critical, and personalizing the in-car experience by learning driver preferences and habits. As AI continues to evolve, its integration into automotive applications promises to transform how we drive, maintain, and interact with our vehicles.

Another trend shaping the modern automotive landscape is that of the increased application of networks and collaboration between networked subsystems to automobiles in general. In modern vehicles, networks between subsystems play a crucial role in enabling efficient communication and coordination among various components, such as sensors, controllers, and actuators. Traditionally, vehicles used distributed electrical architectures where each system had its dedicated wiring, leading to complexity and weight. To address this, the industry has shifted toward more integrated network designs, like Controller Area Networks (CAN) and Ethernet, which reduce wiring and enhance data flow between subsystems. The advent of the Zonal architecture is a key innovation in this space. Zonal protocols focus on grouping electrical components by their physical location rather than by function, connecting them to a central processing unit via high-speed data links. This not only simplifies wiring but also improves scalability, reduces weight, and enhances the vehicle's ability to handle the increasing demands of advanced features, including ADAS. By adopting Zonal architectures, automakers can create smarter, more efficient vehicles with faster communication between subsystems.

AI processing allows for more efficient computation and decision-making, as the system can analyze vast amounts of data in real-time, integrating inputs from different parts of the vehicle to form a cohesive understanding of the driving environment. This is particularly important for advanced functions like autonomous driving, where split-second decisions are required. Modern automobiles can run complex machine learning algorithms and deep neural networks that enable features like object detection, path planning, and predictive analytics. AI is driving the automotive industry towards a future of smarter, more capable, and highly connected vehicles.

However, centralized computing architectures have some issues. In a centralized computing architecture, AI processing is concentrated in a powerful central unit that handles data from various subsystems, including sensors, cameras, radar, and LiDAR. Zonal architectures in automotive systems may organize electrical components based on their physical location rather than function. While this approach simplifies wiring and improves scalability, sending AI workloads from distributed controllers to a central AI accelerator may introduce inefficiencies. In some cases, the centralized approach may result in increased latency due to the time required for sensor data to travel through the zonal network to the centralized AI accelerator and back to the actuators. Network congestion may occur when multiple subsystems simultaneously send data to the central AI accelerator, potentially leading to processing bottlenecks. In addition to latency and bandwidth issues, centralized architecture may also be susceptible to large power and thermal overhead as constantly transmitting large datasets over long distances in a vehicle may consume more power, reducing energy efficiency and necessitating higher cooling requirements. Additionally, a centralized architecture may have low fault tolerance as the central AI accelerator may act as a single point of failure. A single AI accelerator design may be difficult to scale, as the AI accelerator may not be able to handle additional subsystems. In specific embodiments, managing synchronization and data formats between distributed sensors and centralized processing may add software complexity to a centralized architecture.

### SUMMARY

This disclosure relates to distributed subsystems with embedded artificial intelligence (AI) compute in an automotive system. Embodiments disclosed herein utilize an approach in which AI compute capabilities are distributed and embedded within different subsystems in an automobile.

The disclosed architecture enables operating an automotive computing system where AI workloads are assigned and executed locally within each subsystem. For example, each zone in a Zonal architecture could be provided with AI compute capabilities that are shared by the sensors, controllers, and actuators that are grouped into that zone. In another example, each independent subsystem in an automotive computing system could include AI compute capabilities on the board, or other substrate, that houses the controller of the subsystem. In another example, the local controller of each independent subsystem in an automotive computing system could have control over a local AI accelerator. The AI compute capabilities could be provided by a local AI accelerator in the form of a dedicated AI accelerator chip. In specific embodiments, the dedicated AI accelerator chip could be customized for the AI computing requirements of the specific subsystem in which it is embedded. These AI accelerators are designed to perform AI computations for their respective subsystems without utilizing the network, allowing for efficient and localized processing.

To optimize performance and efficiency, the AI accelerators can be customized for their specific tasks using various methods. These may include fine-tuning techniques, which can take into account the physical locations of sensors in each subsystem. Additionally, model pruning, knowledge distillation, or quantization techniques may be employed to further tailor the AI accelerators to their designated applications.

The networked subsystems in this architecture may encompass a range of automotive components, including but not limited to, engine control units, transmission control units, advanced driver-assistance systems, infotainment systems, battery management subsystems, and energy optimization subsystems. Each subsystem may include a set of components such as a controller, a central processing unit, read-only memory, and an Ethernet connection; the components may communicate with each other using a network-on-chip.

Specific embodiments of the inventions disclosed herein alleviate pressure on the network or wiring of the automobile in which they operate in that less data needs to be transmitted from the subsystems to a central AI accelerator, thereby improving the performance of the system overall. Additionally, certain embodiments result in an improvement in the efficiency of the AI computations conducted by the overall system.

This approach to automotive computing architecture represents a significant advancement in distributed AI processing for vehicles, offering potential improvements in efficiency, latency, and overall system performance. A specialized AI accelerator for a subsystem may be efficient, inexpensive, low power, and small because it is specially hardcoded (e.g., not a general purpose component). The weights of the AI accelerator may be hardcoded in ROM instead of being loaded into the device. The AI may be fine-tuned on a larger computer with the results then implemented into the cheaper, specialized AI accelerator. The specialized AI accelerator may be any hardware that is capable of performing the functions that may be required for its subsystem. As faster and more efficient models develop, the AI accelerator may use these models. In specific embodiments, this may mean that utilizing a new model requires replacing the hardware associated with a given sensor or node in a zonal network. However, given that the requirements of the device in a node in a car design are generally fixed for the life of the car, and the savings that can be realized by hardcoding the model into ROM, such approaches can realize significant net benefits.

In specific embodiments of the invention, an automotive computing architecture is provided. The automotive computing architecture comprises: a network, a plurality of networked subsystems in operative communication using the network, and a set of artificial intelligence accelerators in a one-to-one correspondence with the plurality of networked subsystems. The set of artificial intelligence accelerators conduct artificial intelligence computations for their respective networked subsystems without using the network.

In specific embodiments of the invention, a method for operating automotive computing architecture is provided. The method comprises: assigning, by a subsystem controller, an artificial intelligence workload to an artificial intelligence accelerator within a subsystem; receiving data, by the artificial intelligence accelerator and based on the artificial intelligence workload, from a sensor; processing, by the artificial intelligence accelerator, the data; generating, by the artificial intelligence accelerator, an inference based on the processing of the data; and transmitting a command to an actuator based on the generating of the inference. The subsystem is part of a networked system including a plurality of subsystems connected via a network. The plurality of subsystems operatively communicate using the network. The receiving of the data, the processing of the data, and the generating of the inference is conducted within the subsystem without using the network.

In specific embodiments of the invention, an automotive computing architecture is provided. The automotive computing architecture comprises a network and a plurality of networked subsystems in operative communication using the network. Each networked subsystem comprises a controller and an artificial intelligence accelerator configured to conduct an artificial intelligence workload for its respective networked subsystem without using the network.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa.

Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a block diagram of an automotive computing system having a centralized controller and various subsystems in accordance with specific embodiments of the inventions disclosed herein.

FIG. 2 provides an example of a controller of a subsystem in accordance with specific embodiments of the inventions disclosed herein.

FIG. 3 provides an example of a block diagram of an automotive computing system having subsystems with respective AI accelerators in accordance with specific embodiments of the inventions disclosed herein.

FIG. 4 provides an example of an AI being trained and incorporated into an automotive computing system in accordance with specific embodiments of the inventions disclosed herein.

FIG. 5 provides an example of a comparison between centralized and distributed AI processing in an automotive computing system in accordance with specific embodiments of the inventions disclosed herein.

FIG. 6 provides an example of a block diagram of an automotive computing system having a central AI accelerator and specialized subsystem AI accelerators in accordance with specific embodiments of the inventions disclosed herein.

FIG. 7 provides an example of a method of operating an automotive computing architecture in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for distributed subsystems with embedded artificial intelligence (AI) compute in automotive systems in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to subsystems that require AI processing are disclosed herein. In contrast to prior art approaches in the automotive context in which AI processing for various subsystems is conducted in a centralized location, embodiments disclosed herein utilize an approach in which AI compute capabilities are distributed and embedded within different subsystems in the automobile. For example, each zone in a Zonal architecture could be provided with AI compute capabilities that are shared by the sensors, controllers, and actuators that are grouped into that zone. In another example, each independent subsystem in an automotive computing system could include AI compute capabilities on the board, or other substrate, that houses the controller of the subsystem. In another example, the local controller of each independent subsystem in an automotive computing system could have control over a local AI accelerator. The AI compute capabilities mentioned above could be provided by a local AI accelerator in the form of a dedicated AI accelerator chip. In specific embodiments, the dedicated AI accelerator chip could be customized for the AI computing requirements of the specific subsystem in which it is embedded.

Specific embodiments of the inventions disclosed herein alleviate pressure on the network or wiring of the automobile in which they operate in that less data needs to be transmitted from the subsystems to a specific AI accelerator, thereby improving the performance of the system overall. Additionally, as will be described below, certain embodiments result in an improvement in the efficiency of the AI computations conducted by the overall system in comparison to prior art approaches regardless of the fact that those certain embodiments require more discrete AI computation systems.

A specialized AI accelerator for a subsystem may be efficient, inexpensive, low power, and small because it is specially hardcoded (e.g., not a general purpose component). The weights of the AI accelerator may be hardcoded in ROM instead of being loaded into the device. The AI may be fine-tuned on a larger computer, such as one at a testing center, with the results then implemented into the cheaper, specialized AI accelerator. The specialized AI accelerator may be any hardware that is capable of performing the functions that may be required for its subsystem. As faster and more efficient models develop, the AI accelerator may use these models.

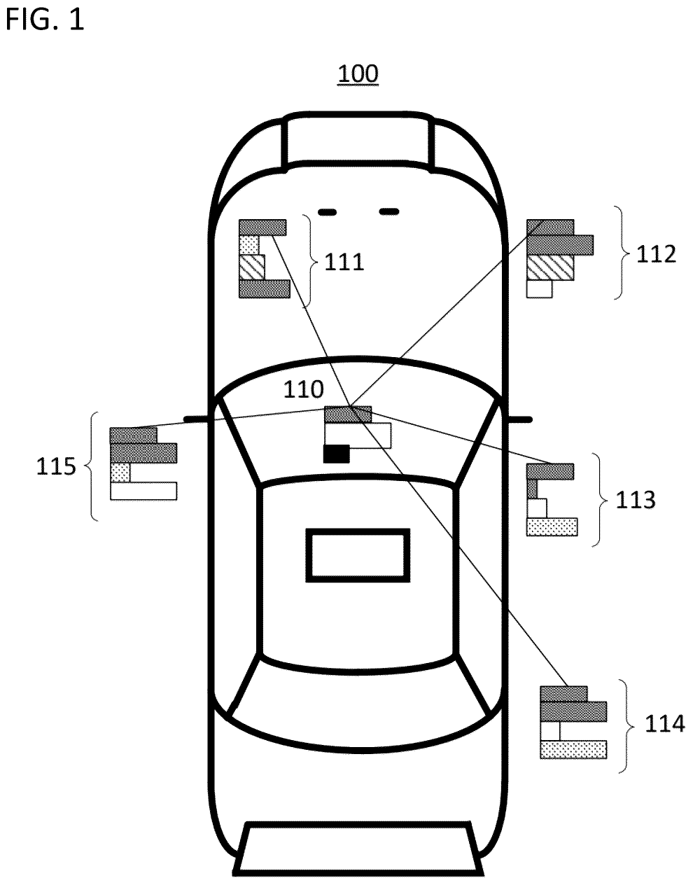

FIG. 1 provides a block diagram of an automotive computing system 100 having a centralized controller 110 and various subsystems 111-115 in accordance with specific embodiments of the inventions disclosed herein. The subsystems can be networked together and can be subservient to the centralized controller 110. The systems can be zones in a Zonal network. The subsystems can include an engine control unit (ECU) which manages engine performance and fuel efficiency, a transmission control unit (TCU) which optimizes gear shifting for smooth operation, advanced driver-assistance systems (ADAS), including features like adaptive cruise control and lane-keeping assist, and an infotainment system. In the context of electric vehicles (EVs) and hybrid vehicles, the subsystems can include battery management and energy optimization subsystems. The subsystems can include various sensors, controllers, and actuators that collect data or control different physical aspects of the automobile.

Centralized controller 110 can include the main computing system for the automotive computing system and can include an AI accelerator for accelerating AI computational workflows. Given that systems such as ADAS and autonomous driving systems require extremely low latencies and fast processing times, the requirements placed on the AI accelerator can be significant. As such, a powerful and resource intensive AI accelerator which is shared by all the subsystems can be beneficial. However, there is a latency introduced through the requirement that the data and inferences need to be sent back and forth through the network of the computing system. Accordingly, in specific embodiments of the invention, each of the various subsystems 111-115 can be provisioned with their own AI Accelerator.

In specific embodiments of the invention, the AI accelerators that are provisioned to the various subsystems can be specialized for the needs of their individual subsystems. For example, if the subsystem were an ADAS system that detects if a pedestrian or cross traffic is about to collide with the car, and automatically engages the brakes, the AI accelerator could be optimized for image processing and zone intrusion detection. As another example, if the subsystem were an energy usage optimization system, the AI accelerator could be optimized for analyzing long sequences of data regarding the performance of the car and the distribution of energy to the wheels. In specific embodiments of the invention, a single automotive computing system could include various specialized AI accelerators that were each optimized for their specific tasks. In the context of a Zonal system, the AI accelerators could be optimized for a bundle of tasks that were grouped together in a given zone of the Zonal system.

In specific embodiments, the AI accelerators that are used in a given automotive computing architecture are derived from a single chip design and may be optimized for a given set of AI workloads. For example, the chip could include a field programmable gate array (FPGA) that could be configured to form different AI compute engines for different AI workloads. In the alternative, or in combination, the chip could include a memory for storing model data for a model that has been trained for specialized workloads. The specialized workload could be the set of tasks that are conducted by the subsystems assigned to a specific zone of a Zonal architecture.

In specific embodiments, when an AI accelerator was fabricated or when it was deployed for operation, the AI accelerator could be configured to operate for specific tasks by optimizing the AI compute engine or the model data of the AI accelerator. Part of this process could include training the model for a specific task such as by using fine-tuning methods. Fine-tuning machine learning models involves adjusting pre-trained models to better suit specific applications. One common method is transfer learning, where a model trained on a large dataset is adapted to a smaller, task-specific dataset by modifying its layers or re-training parts of it. Feature extraction is another approach, where the model's learned features are used as inputs to a simpler model that focuses on the target task. Parameter tuning involves optimizing hyperparameters such as learning rates or regularization techniques to enhance model performance. Additionally, domain adaptation adjusts the model to better handle variations between training and target domains.

In addition or in combination with fine-tuning, simplifying machine learning models for specific tasks can increase efficiency and make them more suitable for deployment in resource-constrained environments. Model pruning is one technique where less important weights or neurons are removed, reducing the model's size and complexity without significantly sacrificing performance. Knowledge distillation involves training a smaller model (student) to replicate the behavior of a larger, more complex model (teacher), transferring key knowledge while minimizing computational demands. Quantization is another method where model parameters are converted from high-precision to lower-precision formats, reducing both memory usage and computational load. These strategies make the model more specialized and easier to deploy for particular applications, like mobile devices or real-time systems. These techniques could be used to take a larger and more resource intensive model, such as a model used for computer vision generally, and to produce a more efficient model used for a specific context such as zone intrusion detection or object classification.

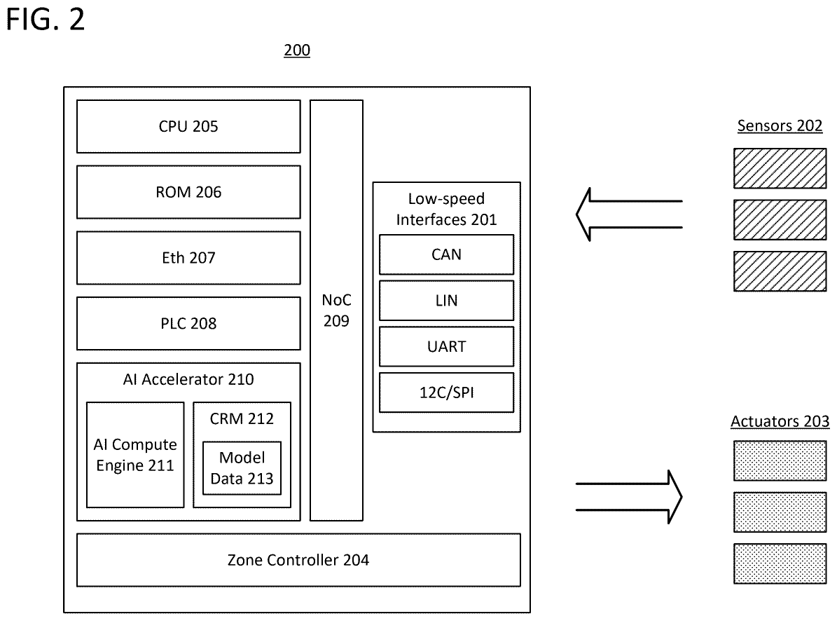

FIG. 2 illustrates controller 200 of a subsystem in accordance with specific embodiments of the inventions disclosed herein. Controller 200 includes low-speed interfaces 201 to interface with the sensors 202 and actuators 203 that are a part of the subsystem's purview. Controller 200 also includes zone controller 204, CPU 205 (CPU 205 may be a RISC-V CPU), ROM memory 206, Ethernet connection 207, and programmable logic controller (PLC) 208. The various components of controller 200 can be linked and communicate using a network-on-chip (NoC) 209. As illustrated, controller 200 also includes AI accelerator 210 to which controller 200 can assign AI workloads.

Controller 200 includes low-speed interfaces 201 to interface with the sensors 202 and actuators 203 that are a part of the subsystem's purview. Low-speed interfaces 201 may include a controller area network (CAN), local interconnect network (LIN), universal asynchronous receiver transmitter (UART), inter-integrated circuit (I2C), serial peripheral interface (SPI), and others. Sensors 202 may include oil pressure sensors, intake air temperature sensors, vehicle speed sensors, cameras, radar, LiDAR, ultrasonic sensors, microphones, proximity sensors, etc. Actuators may include brake actuators, steering actuators, fuel injectors, cooling fans, hydraulic valves, gear selector motors, throttle actuators, seat adjustment motors, etc. Sensors and actuators in a subsystem may be based on the zone type.

Controller 200 may include AI accelerator 210 to which it can assign AI workloads. In specific embodiments, AI accelerator 210 may be physically separate from controller 200 but may still be subservient to controller 200. The AI workloads can involve receiving data from sensors 202, processing the data, and generating inferences that will either be used directly as commands for actuators 203, or that will be used to generate those commands. The AI workloads can therefore be conducted entirely within the confines and ambit of the subsystem itself without needing to send data through the network.

AI accelerator 210 may include AI compute engine 211 and a computer-readable medium (CRM) 212 storing model data 213. AI compute engine 211 can use model data 213 to run inferences to support the AI workloads assigned to it by controller 200. Computer-readable medium 212 can be non-transitory. Computer-readable medium 212 can be nonvolatile memory used by the firmware of the controller, and model data 213 can be loaded onto AI accelerator 210 by being flashed into the nonvolatile memory. AI accelerator 210 can be an embedded system and AI accelerator 210 and model data 213 can be configured when the embedded system is configured for deployment prior to reaching an end user. Computer-readable medium 212 can be one-time programmable memory. Computer-readable medium 212 can be mask ROM or other ROM that is programmed as AI accelerator 210 is being fabricated. Computer-readable medium 212 can be PROM, EPROM, or EEPROM. Computer-readable medium 212 may be a representation of multiple separate computer-readable media.

In specific embodiments, a set of distributed specialized AI accelerators, each optimized for specific workloads of their subsystems, can be more effective than a single centralized AI accelerator designed to handle all the tasks of those subsystems. Specialized accelerators can be tailored to the unique computational demands of different types of AI tasks, such as natural language processing, computer vision, reinforcement learning, obstacle avoidance, zone intrusion, object classification, LiDAR image processing, etc. By using distributed accelerators, each task can be handled by hardware optimized for its specific needs, resulting in higher efficiency, lower latency, and better power management. In contrast, a centralized AI accelerator that is generalized for all workloads often faces inefficiencies, as it lacks the deep optimization needed for any single task. Furthermore, the distributed accelerators can provide greater scalability, redundancy, and fault tolerance, enabling better performance across diverse workloads.

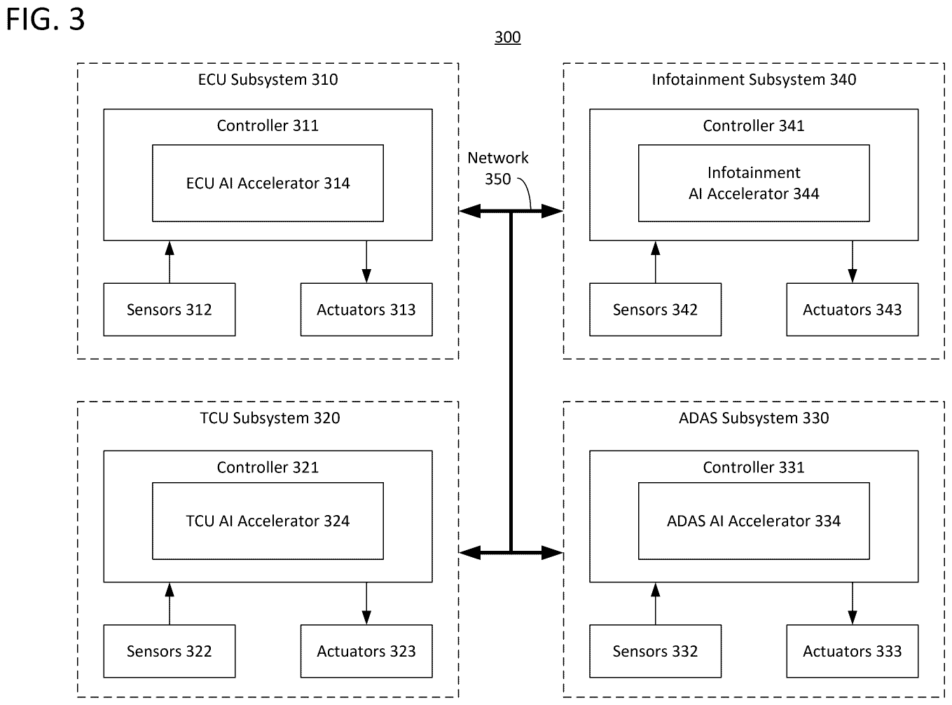

FIG. 3 provides a block diagram of automotive computing system 300 having subsystems 310, 320, 330, and 340 with AI accelerators 314, 324, 334, and 344 respectively in accordance with specific embodiments of the inventions disclosed herein. Subsystems 310, 320, 330, and 340 may be networked together via network 350 and can be subservient to a centralized controller (not shown). Subsystems 310, 320, 330, and 340 can be zones in a Zonal network. Each subsystem 310, 320, 330, and 340 may include sensors 312, 322, 332, and 342, respectively, that collect data and may include actuators 323, 323, 333, and 343 respectively that control different physical aspects of the automobile. Each of the various subsystems 310, 320, 330, and 340 may be provisioned with their own AI accelerator 314, 324, 334, and 344 to prevent latency associated with sending data and inferences through network 350 and to allow the AI accelerators to be specialized for that subsystem. Controllers 311, 321, 331, and 341 may assign AI workloads to their respective AI accelerators 314, 324, 334, and 344.

Subsystems 310, 320, 330, and 340 may be in charge of specific aspects of automotive computing system 300. Respective AI accelerators may be specialized for those specific aspects. Subsystem 310 may be an engine control unit (ECU) which manages engine performance and fuel efficiency. Subsystem 320 may be a transmission control unit (TCU) which optimizes gear shifting for smooth operation. Subsystem 330 may be an advanced driver-assistance systems (ADAS), including features like adaptive cruise control and lane-keeping assist. Subsystem 340 may be an infotainment system. In specific embodiments, automotive computing system 300 may be part of an electric vehicle (EV) or hybrid vehicles and may include additional subsystems such as a battery management subsystem and an energy optimization subsystem.

In specific embodiments of the invention, the AI accelerators that are provisioned to the various subsystems can be specialized for the needs of their individual subsystems. ADAS subsystem 330 may detect if a pedestrian or cross traffic is about to collide with the car and may automatically engage the brakes; AI accelerator 334 could be optimized for image processing and zone intrusion detection for this purpose in order to determine if a pedestrian or cross traffic were about to collide with the car.

As another example, if the subsystem were an energy usage optimization system, the AI accelerator could be optimized for analyzing long sequences of data regarding the performance of the car and the distribution of energy to the wheels. Automotive computing system 300 may include various specialized AI accelerators (including AI accelerators 314, 324, 334, and 344) that are each optimized for their specific tasks. In the context of a Zonal system, the AI accelerators could be optimized for a bundle of tasks that were grouped together in a given zone of the Zonal system.

In specific embodiments, the AI accelerators that are used in a given automotive computing architecture are derived from a single chip design and may be optimized for a given set of AI workloads. For example, the chip could include an FPGA that could be configured to form different AI compute engines for different AI workloads. In the alternative, or in combination, the chip could include a memory for storing model data for a model that has been trained for specialized workloads. The specialized workload could be the set of tasks that are conducted by the subsystems assigned to a specific zone of a Zonal architecture.

Controllers 311, 321, 331, and 341 may include low-speed interfaces to interface with their respective sensors 312, 322, 332, and 342 and their respective actuators 313, 323, 333, and 343 that are a part of the subsystem's purview. The types of sensors and actuators may be based on the specific type of subsystem to which they belong.

Controller 311 may include AI accelerator 314 to which it can assign AI workloads. In specific embodiments, AI accelerator 314 may be physically separate from controller 311 but may still be subservient to controller 311. The AI workloads can involve receiving data from sensors 312, processing the data, and generating inferences that will either be used directly as commands for actuators 313, or that will be used to generate those commands. The AI workloads can therefore be conducted entirely within the confines and ambit of subsystem 310 itself without needing to send data through network 350. Subsystems 320, 330, and 340 may behave similarly to subsystem 310 but may be specialized for other tasks.

AI accelerator 314 may include an AI compute engine and a computer-readable medium storing model data. The AI compute engine can use the model data to run inferences to support the AI workloads assigned to it by controller 311. The computer-readable medium can be non-transitory. The computer-readable medium can be nonvolatile memory for the firmware of the controller and the model data can be loaded onto AI accelerator 314 by being flashed into the firmware. AI accelerator 314 can be an embedded system and AI accelerator 314 and the model data can be configured when the embedded system is configured for deployment prior to reaching an end user. The computer-readable medium can be one-time programmable memory. The computer-readable medium can be mask ROM or other ROM that is programmed as AI accelerator 314 is being fabricated. The computer-readable medium can be PROM, EPROM, or EEPROM.

Sensors 312, 322, 332, and 342 may overlap in sensor use. For example, sensors 312, 322, and 332 may include the same speed sensor. ECU AI accelerator 314, TCU AI accelerator 324, and ADAS AI accelerator 334 may analyze the data from the speed sensor in specialized ways according to their subsystem objectives. For example, the subsystems may analyze different data from the same sensor or may analyze the same data differently. In specific embodiments, ECU AI accelerator 314, TCU AI accelerator 324, and ADAS AI accelerator 334 may analyze data from different sensors which are specialized for their subsystem objectives. In specific embodiments, the AI accelerators may be integrated with the controllers and may be replaced when the controllers are replaced (i.e., a mask ROM model in an AI accelerator could be integrated with a corresponding controller where it is optimized to handle workloads particular to that controller and could be replaced when the controller is replaced). While the AI accelerators in FIG. 3 are shown as part of the controllers in specific embodiments, the AI accelerators may be integrated with the sensors and may be replaced when the sensors are replaced (i.e., a mask ROM model in an AI accelerator could be integrated with a corresponding sensor where it is optimized to handle data from that particular sensor and could be replaced when the sensor is replaced. The different speed sensors may be at different physical locations.

A subsystem may include multiple of the same type of sensor. The AI accelerator of the subsystem may be fine-tuned according to the locations of each sensor. For example, ADAS subsystem 330 may include at least two ultrasonic sensors; a first ultrasonic sensor may be on a left side of the automobile and a second ultrasonic sensor may be on a right side of the automobile. ADAS AI accelerator 334 may be trained (e.g., fine-tuned) to know that the first ultrasonic sensor is on the left and the second ultrasonic sensor is on the right. Accordingly, AI accelerator 334 may be specialized for the system set up (e.g., sensor locations) of the automobile. In specific embodiments, a sensor can be set up specifically to be at a given location on the automobile. AI accelerators 314, 324, 334, and 344 may receive inputs from sensors 312, 322, 332, and 342 in their respective subsystems. The fine-tuning methods may establish locations of sensors 312, 322, 332, and 342. AI accelerators 314, 324, 334, and 344 may conduct AI computations (e.g., workloads) based on the locations of the sensors in their respective subsystems.

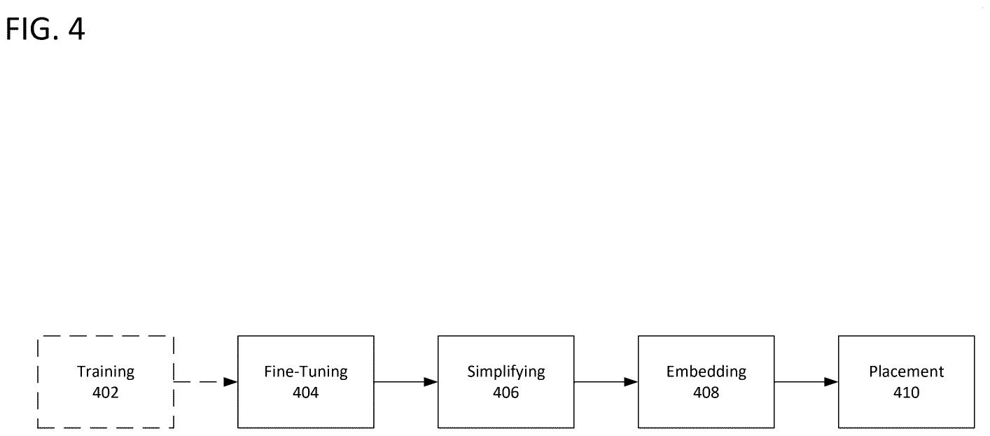

FIG. 4 illustrates an example of an AI being trained and incorporated into an automotive computing system in accordance with specific embodiments of the inventions disclosed herein. An AI accelerator could be configured to operate for specific tasks when it was fabricated or when it was deployed for operation. In specific embodiments, the AI accelerator could be configured to operate for specific tasks by optimizing the AI compute engine or the model data of the AI accelerator. A single AI accelerator may undergo steps 402-410 or multiple AI accelerators may undergo various steps. For example, the results of the training, fine-tuning, and simplifying steps of a single AI may be used to embed multiple AI accelerators.

In specific embodiments, before an AI accelerator is configured to operate for specific tasks, the AI accelerator may be generally trained at training step 402. Any AI model may be used which is capable of performing the functions that may be required for its subsystem. As faster and more efficient models develop, the AI accelerator may use these models. Training step 402 may include prompting the AI. Prompting may be an easy, low-cost way to change the AI model. Appropriate prompting may make an AI accelerator more specialized for the specific subsystem, zone, or location that incorporates that AI accelerator.

Part of the process configuring the AI accelerator to operate for specific tasks could include training the model for a specific task such as by fine-tuning the AI accelerator at fine-tuning step 404. Fine-tuning AI accelerator may involve adjusting pre-trained models (e.g., trained at training step 402) to better suit specific applications. Fine-tuning step 404 may include transfer learning. For example, a model trained on a large dataset may be adapted to a smaller, task-specific dataset by modifying its layers or re-training parts of it. Fine-tuning step 404 may include feature extraction. For example, the model's learned features may be used as inputs to a simpler model that focuses on the target task. Fine-tuning step 404 may include parameter tuning. For example, hyperparameters, such as learning rates or regularization techniques, may be optimized to enhance model performance. Additionally, domain adaptation may adjust the model to better handle variations between training and target domains. In specific embodiments, the AI may be fine-tuned to know relevant sensor locations. AI accelerators may be fine-tuned for specific tasks.

In addition or in combination with fine-tuning step 404, an AI accelerator may undergo simplifying step 406. Simplifying the AI accelerator for specific tasks can increase efficiency and make it more suitable for deployment in resource-constrained environments. Simplifying step 406 may include model pruning. For example, less important weights or neurons may be removed, reducing the model's size and complexity without significantly sacrificing performance. Simplifying step 406 may include knowledge distillation. For example, a smaller model (student) may be trained to replicate the behavior of a larger, more complex model (teacher). Key knowledge may be transferred to the smaller model while minimizing the computational demands of the smaller model. Simplifying step 406 may include quantization. For example, model parameters may be converted from high-precision to lower-precision formats, reducing both memory usage and computational load. Simplifying step 406 may make the model more specialized and easier to deploy for particular applications, like mobile devices or real-time systems. Simplifying step 406 may be used to take a larger and more resource intensive model, such as a model used for computer vision generally, and to produce a more efficient model used for a specific context such as zone intrusion detection or object classification.

At embedding step 408, the AI accelerator may be embedded into a chip. In specific embodiments, the AI accelerator may be on the board, or other substrate, that houses a controller that assigns the AI accelerator workloads. In specific embodiments, the AI accelerator may be in the form of a dedicated AI accelerator chip. The dedicated AI accelerator chip may be customized for the AI computing requirements of a specific subsystem in which it is embedded. The AI accelerator may be an embedded system and both the AI accelerator and the model data may be configured when the embedded system is configured for deployment prior to reaching an end user.

At placement step 410, the AI accelerator core may be placed into an automobile. In specific embodiments, placing step 410 may include attaching the AI accelerator to its specific sensors and actuators. AI compute capabilities may be distributed and embedded within different subsystems in the automobile. For example, each zone in a Zonal architecture could be provided with AI compute capabilities that are shared by the sensors, controllers, and actuators that are grouped into that zone. In another example, each independent subsystem in an automotive computing system could include AI compute capabilities on the board, or other substrate, that houses the controller of the subsystem. In another example, the local controller of each independent subsystem in an automotive computing system could have control over a local AI accelerator.

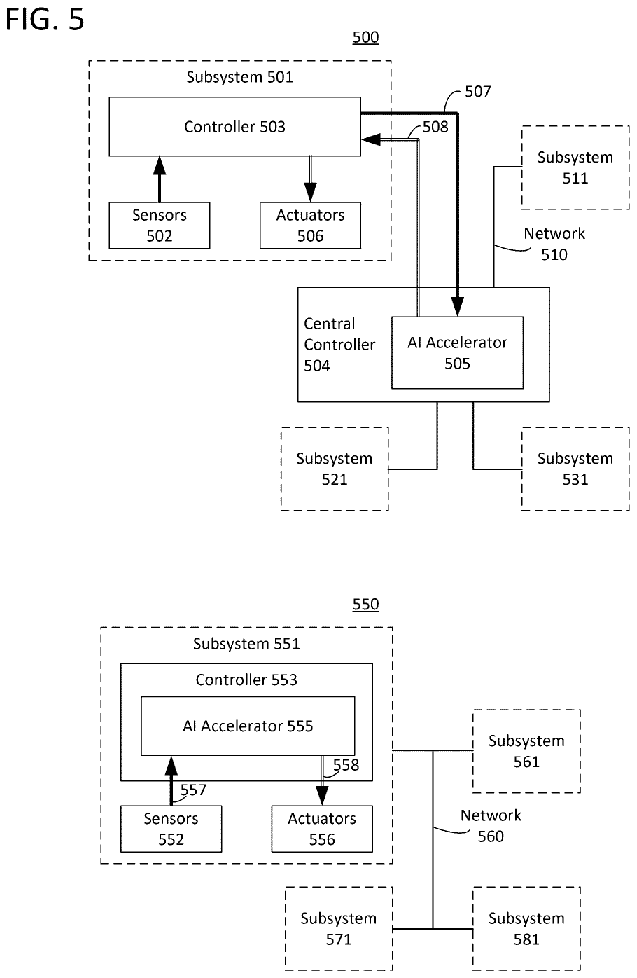

FIG. 5 illustrates a comparison between centralized and distributed AI processing in an automotive computing system in accordance with specific embodiments of the inventions disclosed herein. In a centralized architecture, embedded controllers in various subsystems send workloads through a zonal network to a central AI accelerator. This approach may present challenges in terms of latency, network congestion, and scalability. The distributed approach, as shown in FIG. 5, may address these challenges by incorporating local AI accelerators within each subsystem. This configuration may allow for AI computations to be performed closer to the data source, potentially reducing latency and network traffic.

Centralized architecture 500 includes subsystems 501, 511, 521, and 531 in zonal network 510. Embedded controller 503 in subsystem 501 may send workloads through zonal network 510 to AI accelerator 505 through central controller 504. Zonal architectures in automotive systems may organize electrical components based on their physical location rather than function. While this approach simplifies wiring and improves scalability, sending AI workloads from distributed controllers to a central AI accelerator may introduce inefficiencies. In some cases, the centralized approach may result in increased latency due to the time required for data from sensors 502 to travel through zonal network 510 to AI accelerator 505 via path 507 and back to actuators 506 via path 508. Network congestion may occur when multiple subsystems simultaneously send data to AI accelerator 505, potentially leading to processing bottlenecks. In addition to latency and bandwidth issues, centralized architecture may also be susceptible to large power and thermal overhead as constantly transmitting large datasets over long distances in a vehicle may consume more power, reducing energy efficiency and necessitating higher cooling requirements. Additionally, centralized architecture 500 may have low fault tolerance as AI accelerator 505 may act as a single point of failure. A single AI accelerator design may be difficult to scale, as the AI accelerator may not be able to handle additional subsystems. In specific embodiments, managing synchronization and data formats between distributed sensors and centralized processing may add software complexity to a centralized architecture.

Distributed architecture 550 may address these challenges by incorporating local AI accelerators within each subsystem. This configuration may allow for AI computations to be performed closer to the data source (e.g., sensors 552) and to the command destination (e.g., actuators 506), potentially reducing latency and network traffic. Distributed architecture 550 includes subsystems 551, 561, 571, and 581 in zonal network 560. Embedded controller 553 in subsystem 551 may send workloads to AI accelerator 555 directly, without using zonal network 560. AI accelerator 555 may be local to subsystem 551. In some implementations, AI accelerator 555 may process data from sensors 552 and generate commands for actuators 556 within subsystem 551 without utilizing zonal network 560. This approach may alleviate pressure on the network and improve overall system performance. In specific embodiments, a subsystem AI accelerator may only be coupled with a subset of the sensors of the automobile. Accordingly, the subsystem AI accelerator may not need to manage or synchronize with as large a variety of sensors and data formats as a central AI accelerator. The subsystem AI accelerator may then be smaller, cheaper, and more efficient at common tasks for that subsystem and may have simpler software.

Distributed architecture 550 may offer benefits such as reduced latency, improved scalability, and enhanced fault tolerance. For example, path 557 may be shorter than, and create less latency than, path 507. Furthermore, path 557 may be a direct analog signal connection or a simplified digital connection that does not need to be translated and sent through a network such as a zonal network, and therefore create less latency than, path 507. Similarly, path 558 may be shorter than, and create less latency than, path 508. Furthermore, path 558 may be a direct analog signal connection or a simplified digital connection that does not need to be translated and sent through a network such as a zonal network, and therefore create less latency than, path 508. By processing AI workloads locally, each subsystem may operate more independently, potentially increasing the robustness of the overall system. In specific embodiments, an automotive architecture may use both centralized and distributed AI processing. Some workloads may remain local to the subsystem while other workloads may be centralized. For example, a central AI accelerator may still coordinate between subsystems.

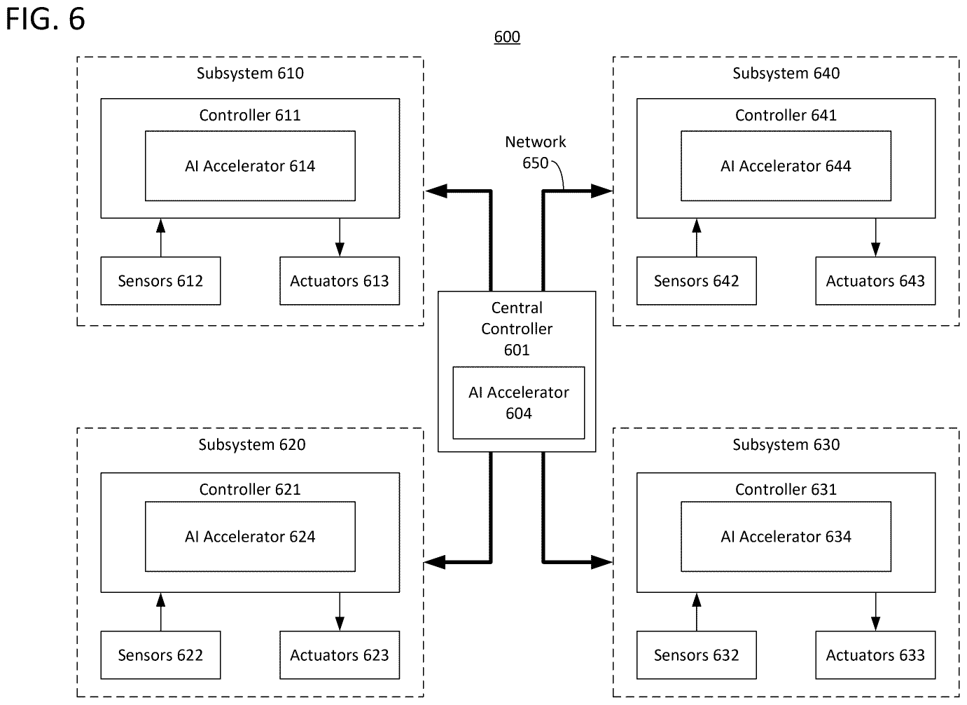

FIG. 6 provides a block diagram of automotive computing system 600 having central AI accelerator 604 and subsystems 610, 620, 630, and 640 with AI accelerators 614, 624, 634, and 644 respectively in accordance with specific embodiments of the inventions disclosed herein. Subsystems 610, 620, 630, and 640 may be networked with (e.g., via network 650), and subservient to, central controller 601. Subsystems 310, 320, 330, and 340 can be zones in a Zonal network. Each subsystem 610, 620, 630, and 640 may include sensors 612, 622, 632, and 642, respectively, that collect data and may include actuators 623, 623, 633, and 643 respectively that control different physical aspects of the automobile. Each of the various subsystems 610, 620, 630, and 640 may be provisioned with their own AI accelerator 614, 624, 634, and 644 to prevent latency associated with sending data and inferences through network 650 and to allow the AI accelerators to be specialized for that subsystem. Controllers 611, 621, 631, and 641 may assign AI workloads to their respective AI accelerators 314, 324, 334, and 344. Subsystems 610, 620, 630, and 640 may be in charge of specific aspects of automotive computing system 600. Respective AI accelerators may be specialized for those specific aspects. The types of sensors and actuators in a subsystem may also be specialized for the specific subsystem to which they belong.

In specific embodiments, the AI accelerators that are used in a given automotive computing architecture are derived from a single chip design and may be optimized for a given set of AI workloads. For example, the chip could include an FPGA that could be configured to form different AI compute engines for different AI workloads. In the alternative, or in combination, the chip could include a memory for storing model data for a model that has been trained for specialized workloads. The specialized workload could be the set of tasks that are conducted by the subsystems assigned to a specific zone of a Zonal architecture.

In specific embodiments, AI workloads may be conducted entirely within the confines and ambit of a subsystem itself without needing to send data through network 650. For example, controller 611 may include AI accelerator 614 to which it can assign AI workloads. In specific embodiments, AI accelerator 614 may be physically separate from controller 611 (although shown in FIG. 6 as contained within controller 611) but may still be subservient to controller 611. The AI workloads can involve receiving data from sensors 612, processing the data, and generating inferences that will either be used directly as commands for actuators 613, or that will be used to generate those commands. The AI workloads can therefore be conducted entirely within the confines and ambit of subsystem 610 itself without needing to send data through network 650. Subsystems 620, 630, and 640 may behave similarly to subsystem 610 but may be specialized for other tasks (e.g., ECU, TCU, ADAS, infotainment, battery management, energy optimization, etc.).

In specific embodiments, some AI workloads may be conducted in central AI accelerator 604. For example, controller 611 or AI accelerator 614 may determine that an AI workload would be performed better by central AI accelerator 604 than by subsystem AI accelerator 614. An AI workload may, for example, be sent to central AI accelerator 604 if the AI workload itself is too much for AI accelerator 614 to handle in the required time or if AI accelerator 614 has a large workload and AI accelerator 604 is available to accept offloaded work. AI accelerator 614 may be specialized to typical use cases for subsystem 610. Rather than include complicated software, extra hardware (which may be expensive), or generalized models (which may be power intensive) edge cases for subsystem 610 may be sent to AI accelerator 604. For example, optimizing an AI accelerator for typical use cases may not allow extreme cases. These extreme cases may then be handled by central AI accelerator 604 which may be more general purpose than the specialized subsystem AI accelerators.

AI accelerator 614 may be efficient, inexpensive, low power, and small because it is specially hardcoded and not a general purpose component. The weights of AI accelerator 614 may be hardcoded in ROM instead of being loaded into the device. For example, an AI accelerator coupled with a camera may be hardcoded for image processing and zone intrusion detection. The AI may be fine-tuned on a larger computer, such as one at a research center, with the results then implemented into the cheaper, specialized AI accelerators. The specialized AI accelerator may be any hardware that is capable of performing the functions that may be required for its subsystem. As faster and more efficient models develop, the AI accelerator may use these models.

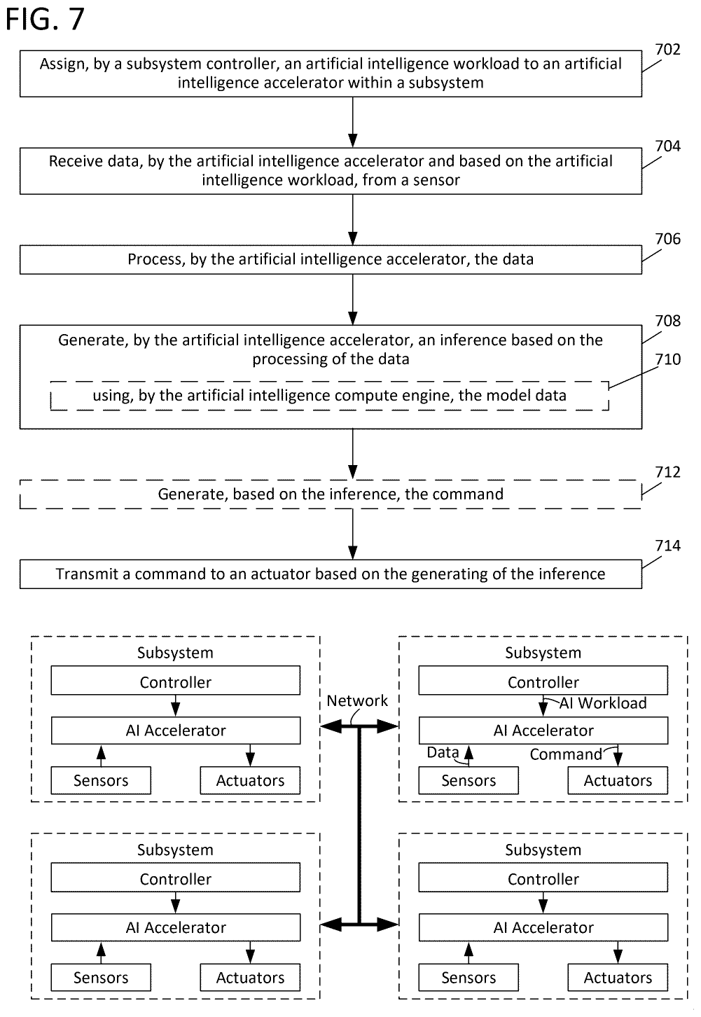

FIG. 7 provides an example of method 700 of operating an automotive computing architecture in accordance with specific embodiments of the inventions disclosed herein. Method 700 may be computer-implemented. Method 700 may be implemented by a system including a network, a plurality of networked subsystems, and a set of AI accelerators. In specific embodiments, the system may also include a set of embedded controllers, a set of computer-readable media, one or more sensors, and one or more actuators. Method 700 may be implemented by a system including means for performing the steps of method 700. Steps, or portions of steps, of method 700 may be duplicated, omitted, rearranged, or otherwise deviate from the form shown. Additional steps may be added to method 700. Steps, or portions of steps, of method 700 may be performed in series or parallel.

At step 702, a subsystem controller may assign an AI workload to an AI accelerator within a subsystem. The subsystem may be part of a networked system including a plurality of subsystems connected via a network. The plurality of subsystems may operatively communicate using the network. In specific embodiments, the network may be a zonal network, and the plurality of networked subsystems may be zones in the zonal network. In specific embodiments, the plurality of networked subsystems may include an engine control unit, a transmission control unit, an advanced driver-assistance systems, an infotainment system, a battery management subsystem, an energy optimization subsystem, or a combination thereof. In specific embodiments, the plurality of AI accelerators may be in a one-to-one correspondence with the plurality of networked subsystems and the set of AI accelerators may conduct AI computations for their respective networked subsystems without using the network.

In specific embodiments, each networked subsystem in the plurality of networked subsystems may include a set of components. The set of components may include a controller, a central processing unit, read-only memory, and an Ethernet connection. The set of components of the networked subsystem may communicate with each other using a network-on-chip.

In specific embodiments, the AI accelerator may include an AI compute engine and a computer-readable medium storing model data. The model data may be for a set of models used by the set of AI accelerators. In specific embodiments, the computer-readable medium may be firmware. In specific embodiments, the model data may be customized for the AI workload; the set of models may be customized for AI applications conducted by their networked subsystems. In specific embodiments, the set of AI accelerators may be customized for the AI applications conducted by their networked subsystems using fine-tuning methods. The set of AI accelerators may be customized for the AI applications conducted by their networked subsystems using model pruning, knowledge distillation, or quantization.

In specific embodiments, the system may include a set of embedded controllers for the plurality of networked subsystems. The set of AI accelerators may be subservient to the set of embedded controllers. In specific embodiments, each AI accelerator in the set of AI accelerators may be on a same substrate as the embedded controller, in the set of embedded controllers, to which it is subservient.

At step 704, the AI accelerator may receive data from a sensor. The data may be received based on the AI workload (e.g., assigned at step 702). The receiving of the data may be conducted within the subsystem without using the network. In specific embodiments, the sensor data (e.g., sensor inputs) may be from the respective zone of the AI accelerator.

At step 706, the AI accelerator may process the data. The processing of the data may be conducted within the subsystem without using the network. In specific embodiments, fine-tuning methods may establish the locations of sensors and conducting the AI computations (e.g., processing the data) may be based on the locations of the sensors in their respective subsystems.

At step 708, the AI accelerator may generate an inference based on the processing of the data (e.g., at step 706). The generating of the inference may be conducted within the subsystem without using the network.

In specific embodiments and as part of generating the inference, at step 710, the AI compute engine may use the model data.

In specific embodiments, the inference (e.g., generated at step 708) may be a command. In specific embodiments, at step 712, the command may be generated based on the inference.

At step 714, a command may be transmitted to an actuator based on the generating of the inference (e.g., at step 708). In specific embodiments, the command may be to an actuator in the respective zone of the AI accelerator.

In specific embodiments, a set of distributed specialized AI accelerators, each optimized for specific workloads of their subsystems, can be more effective than a single centralized AI accelerator designed to handle all the tasks of those subsystems. Specialized accelerators can be tailored to the unique computational demands of different types of AI tasks, such as natural language processing, computer vision, reinforcement learning, obstacle avoidance, zone intrusion, object classification, LiDAR image processing, etc. By using distributed accelerators, each task can be handled by hardware optimized for its specific needs, resulting in higher efficiency, lower latency, and better power management. In contrast, a centralized AI accelerator that is generalized for all workloads often faces inefficiencies, as it lacks the deep optimization needed for any single task. Furthermore, the distributed accelerators can provide greater scalability, redundancy, and fault tolerance, enabling better performance across diverse workloads. In specific embodiments, using a combined approach of both specialized subsystem AI accelerators and a central general purpose AI accelerator may allow the subsystem AI accelerators to be cheaper and more efficient and typical use tasks.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, while embedding AI processing capabilities into subsystems in an automotive context was provided as an example application of some of the embodiments disclosed herein, the disclosed approaches can beneficially be applied to alternative context which include multiple subsystems with discrete AI computer requirements. These and other modifications and variations to the present invention may be practiced by those skilled in the art, without departing from the scope of the present invention, which is more particularly set forth in the appended claims.

What is claimed is:

1. An automotive computing architecture comprising:
a network;
a plurality of networked subsystems in operative communication using the network; and
a set of artificial intelligence accelerators in a one-to-one correspondence with the plurality of networked subsystems;
wherein the set of artificial intelligence accelerators conduct artificial intelligence computations for their respective networked subsystems without using the network.

2. The automotive computing architecture of claim 1, wherein:
the network is a zonal network;
the plurality of networked subsystems are zones in the zonal network; and
the set of artificial intelligence accelerators receive inputs from sensors in their respective zone and provide commands to actuators in their respective zone.

3. The automotive computing architecture of claim 1, further comprising:
a set of embedded controllers for the plurality of networked subsystems; and
a set of computer-readable media storing model data for a set of models used by the set of artificial intelligence accelerators;
wherein: (i) the set of artificial intelligence accelerators are subservient to the set of embedded controllers; and (ii) the set of models are customized for artificial intelligence applications conducted by their networked subsystems.

4. The automotive computing architecture of claim 3, wherein:
the set of computer-readable media is firmware.

5. The automotive computing architecture of claim 3, wherein each artificial intelligence accelerator in the set of artificial intelligence accelerators is on a same substrate as the embedded controller, in the set of embedded controllers, to which it is subservient.

6. The automotive computing architecture of claim 3, wherein the set of artificial intelligence accelerators are customized for the artificial intelligence applications conducted by their networked subsystems using fine-tuning methods.

7. The automotive computing architecture of claim 6, wherein:
the set of artificial intelligence accelerators receive inputs from sensors in their respective subsystems;
the fine-tuning methods establish locations of the sensors; and
the set of artificial intelligence accelerators conduct the artificial intelligence computations based on the locations of the sensors in their respective subsystems.

8. The automotive computing architecture of claim 3, wherein the set of artificial intelligence accelerators are customized for the artificial intelligence applications conducted by their networked subsystems using model pruning, knowledge distillation, or quantization.

9. The automotive computing architecture of claim 1, wherein the plurality of networked subsystems includes an engine control unit, a transmission control unit, an advanced driver-assistance systems, and an infotainment system.

10. The automotive computing architecture of claim 9, wherein the plurality of networked subsystems further includes a battery management subsystem and an energy optimization subsystem.

11. The automotive computing architecture of claim 1, wherein:
each networked subsystem in the plurality of networked subsystems includes a set of components, the set of components including a controller, a central processing unit, read-only memory, and an Ethernet connection; and
the set of components of a networked subsystem communicate with each other using a network-on-chip.

12. A method for operating automotive computing architecture comprising:
assigning, by a subsystem controller, an artificial intelligence workload to an artificial intelligence accelerator within a subsystem;
receiving data, by the artificial intelligence accelerator and based on the artificial intelligence workload, from a sensor;
processing, by the artificial intelligence accelerator, the data;
generating, by the artificial intelligence accelerator, an inference based on the processing of the data; and
transmitting a command to an actuator based on the generating of the inference;
wherein (i) the subsystem is part of a networked system including a plurality of subsystems connected via a network; (ii) the plurality of subsystems operatively communicate using the network; and (iii) the receiving of the data, the processing of the data, and the generating of the inference is conducted within the subsystem without using the network.

13. The method of claim 12, wherein the artificial intelligence accelerator includes an artificial intelligence compute engine and a computer-readable medium storing model data.

14. The method of claim 13, wherein the model data is customized for the artificial intelligence workload.

15. The method of claim 13, wherein the generating of the inference comprises using, by the artificial intelligence compute engine, the model data.

16. The method of claim 13, wherein the computer-readable medium is firmware.

17. The method of claim 12, wherein the inference is the command.

18. The method of claim 12, further comprising:
generating, based on the inference, the command.

19. An automotive computing architecture comprising:
a network; and
a plurality of networked subsystems in operative communication using the network; each networked subsystem comprising:
a controller; and
an artificial intelligence accelerator configured to conduct an artificial intelligence workload for its respective networked subsystem without using the network.

20. The automotive computing architecture of claim 19, wherein each networked subsystem further comprises:
one or more sensors; and
one or more actuators;
wherein each artificial intelligence accelerator of each networked subsystem is configured to receive one or more inputs from the one or more sensors in its respective subsystem and to provide one or more commands to the one or more actuators in its respective subsystem.
